(19) United States
(12) Patent Application Publication
(10) Pub. No.: US 2018/0201441 A1
(43) Pub. Date: Jul. 19, 2018

(54) Container Lid Latch

(71) Applicant: United Comb & Novelty Corporation, Leominster, MA (US)

(72) Inventors: Ronald M. Audet, North Smithfield, RI (US); Rebecca B. Foster, West Lebanon, NH (US)

(21) Appl. No.: 15/405,929

(22) Filed: Jan. 13, 2017

(51) Int. Cl. B65F 1/16

(52) U.S. Cl. CPC B65F 1/1615; B65F 1/1623; B65F 1/1646

(57) ABSTRACT

A container lid latch with a securing mechanism to maintain a secure engagement between a lid and a container when the lid is in a closed configuration upon the container, the securing mechanism releasable with the exertion of enough pressure to overcome a resistance of the mechanism held by a retainer.

### FIELD

This disclosure relates to a securing latch for open top containers with lids.

### BACKGROUND

Containers with lids have countless uses today, both inside and outside of the home. Lids on containers keep the contents from being inadvertently spilled or unexpectedly removed. Containers with lids, such as waste receptacles, are often left outside of the home and are susceptible to the unexpected and unwanted attention from wildlife. Also, containers/lids within the home may easily spill their contents if dropped or tipped, etc.

### SUMMARY

There is a need for a latch that will keep lids securely latched to containers, requiring more of an effort to release a securing mechanism. This would avoid many spills and unwelcome lid removals for all sorts of container types and uses.

This disclosure describes a container lid latch designed to secure a container lid to an open top container more effectively than latches which are presently available to consumers. An obvious benefit of the container lid latch would be to secure the top of a waste receptacle well enough to keep persistent wildlife from removing the container contents. But there are many container types which would benefit from this latch because it requires more effort to release. Lids for kitchen and household containers would be more securely held in place if this container lid latch were used to keep containers and lids together. Embodiments may include one of the following features, or any combination thereof.

In one aspect of a container lid latch, the latch may reside on the upper edge of an open top container and the latch may have a distal end with a hold and a securing mechanism. A latch opening may exist in the lid, through which the distal end of the latch may protrude. The lid is in a closed configuration upon the container when the hold clears the latch opening and rests in a neutral closed position overlapping the surface of the lid adjacent to the latch opening and therefore keeping the lid in a closed configuration. The latch opening in the lid may also comprise a retainer of various forms, including a protruding edge on the lid surface surrounding the latch opening. The latch hold may extend beyond the latch opening to secure the lid in the closed configuration. The retainer provides a resistance that the securing mechanism must overcome in order to align the hold with the latch opening, allowing the lid to open from the closed configuration.

Embodiments may include an angled surface of the distal end of the latch which may be pushed by a user in order to overcome the resistance on the securing mechanism of the latch. A user may open the lid from a closed configuration upon the open top container by aligning the hold of the latch with the latch opening so that the lid may be released from its closed configuration. The hold will keep the lid closed as long as it extends over the surface of the lid surrounding the latch opening. The hold will maintain its position over the surface of the lid in its neutral resting position, and therefore the distal end of the latch must be pushed by a user in order to clear the hold from the surface of the lid. The lid latch may be configured such that the distal end of the latch must be pulled to release it. The application of other various forces may be utilized to overcome various other types of resistances that could retain the lid latch components from aligning with the latch opening, such as lifting, turning, squeezing, etc. in order to free a securing mechanism from resistance against its movement.

The lid latch may be attached to the container through a flexible member which may allow the distal end of the latch to be moved from a neutral resting position by applying pressure against it. The flexible member may be of a variety of forms and shapes, including springs or curved surfaces which, when released, will return to their neutral positions. This allows the distal end of the lid latch to be pushed or pulled with enough force to overcome the resistance applied upon the securing mechanism, allowing the hold to be aligned with the latch opening. After the hold clears the latch opening, upon release of the distal end of the lid latch, the hold returns to its neutral resting position. The distal end of the lid latch may feature an angled surface opposing the hold so that the lid may be returned to the closed position without manipulating the latch. When the lid is lowered upon the open top container, the angled surface inserts within the latch opening, beginning at the distal end of the latch, and as the lid continues to close and further the insertion of the distal latch, the angled surface may force the hold, through the flexing of the member, into alignment with the latch opening until it clears the opening. The hold returns to its neutral resting position which is over the lid surface adjacent to the latch opening.

In another embodiment, the lid latch may comprise the distal end of the latch on the lid and the latch opening on the lid. This embodiment of the lid latch functions in the same manner as stated previously except the distal latch would be lowered and inserted within the latch opening on the rim of the container. Also, the latch may be pulled or pushed or manipulated in some other way to allow the securing mechanism to overcome a resistance retaining it in the secure position, holding the lid and the open top container together in the closed configuration.

In another aspect, the container lid latch may feature a hinge upon which the lid and the container are coupled and on which the lid may pivot between an open and a closed configuration. The distal end of the lid latch may protrude from the upper rim of the container and the latch opening for the lid latch may reside in the lid, located so that the tip of the distal end will go through the latch opening as the lid approaches the closed configuration, allowing a latch opening edge to contact the angled surface as the lid further approaches the closed configuration.

In another embodiment, the open top container and the lid may be secured together in the closed configuration through the use of two lid latches, each on opposing sides of the lid and container rim locations. Both latch distal ends may be manipulated in order to overcome the resistances against each individual securing mechanism from each latch. Depending on the orientations of the distal ends of the latches, they may be pushed toward or pulled away from one another in order to release the lid from the container. The distal ends of the latches may protrude from the lid and the latch openings may be in the upper rim of the container, opposing the distal ends in the lid. The distal ends of the latches may also protrude from the upper rim of the container and the latch openings may be in the lid, opposing the distal ends in the container rim.

### BRIEF DESCRIPTION OF THE DRAWINGS

FIG. 1 is a perspective of a lid latch on an open top container with a lid.

FIG. 2 is a top view of an open top container with a lid latch.

FIG. 3 is a cross-section taken along line 3-3, FIG. 2.

FIG. 4 is a detailed cross-section of the lid latch of FIG. 3.

FIG. 5 is a detailed cross-section of the lid latch of FIG. 4 in the open position.

FIG. 6 is a top view of two lid latches on an open top container with a lid.

### DETAILED DESCRIPTION

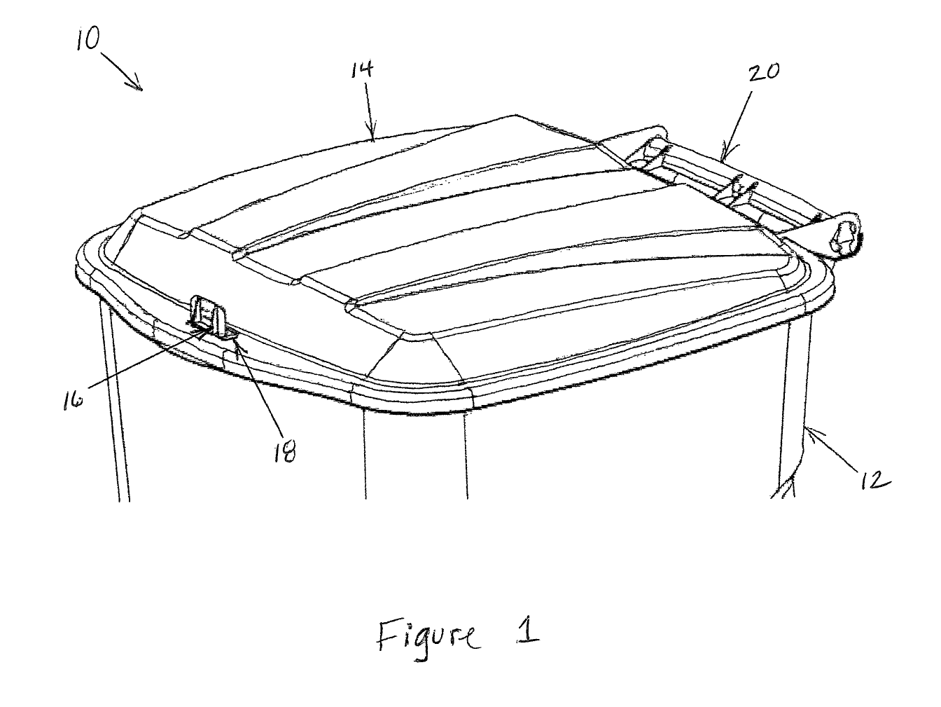

FIG. 1 is a perspective view of a container with lid latch 10 with a container 12, lid 14 and lid latch 16. Lid 14 is in a closed configuration, with lid latch 16 inserted through latch opening 18. Hinge mechanism 20 is shown opposing lid latch 16, together engaging lid 14 with container 12 in the closed configuration.

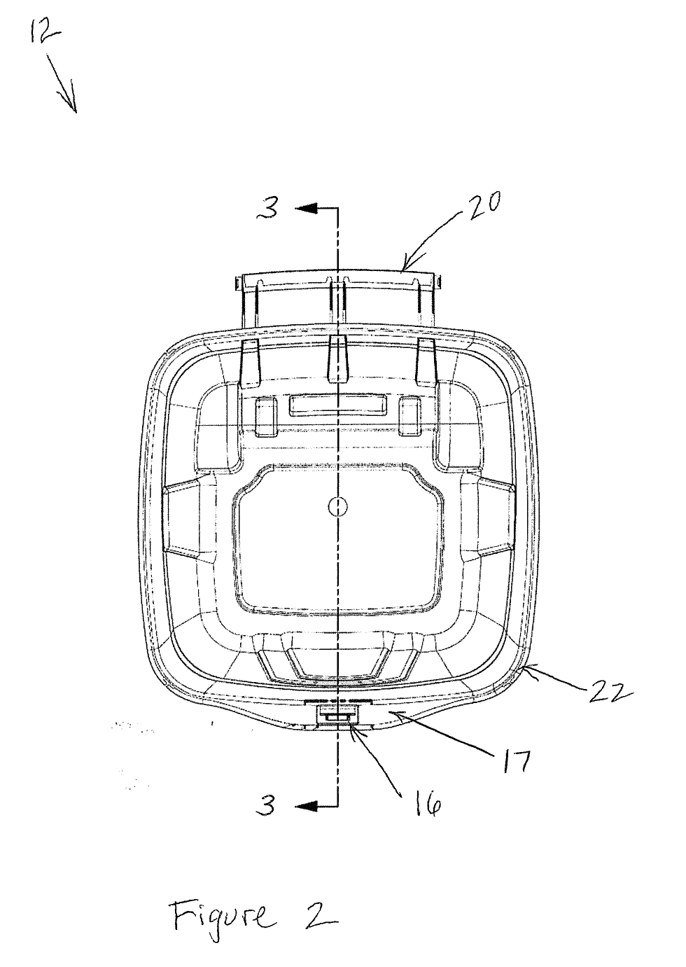

FIG. 2 is a top view of an open top container 12 with lid latch 16 opposing hinge mechanism 20. Upper rim 22 of the open top container 12 can be seen on the outer periphery of the container. Lid latch 16 is located within a broadened area 17 of upper rim 22 of container 12.

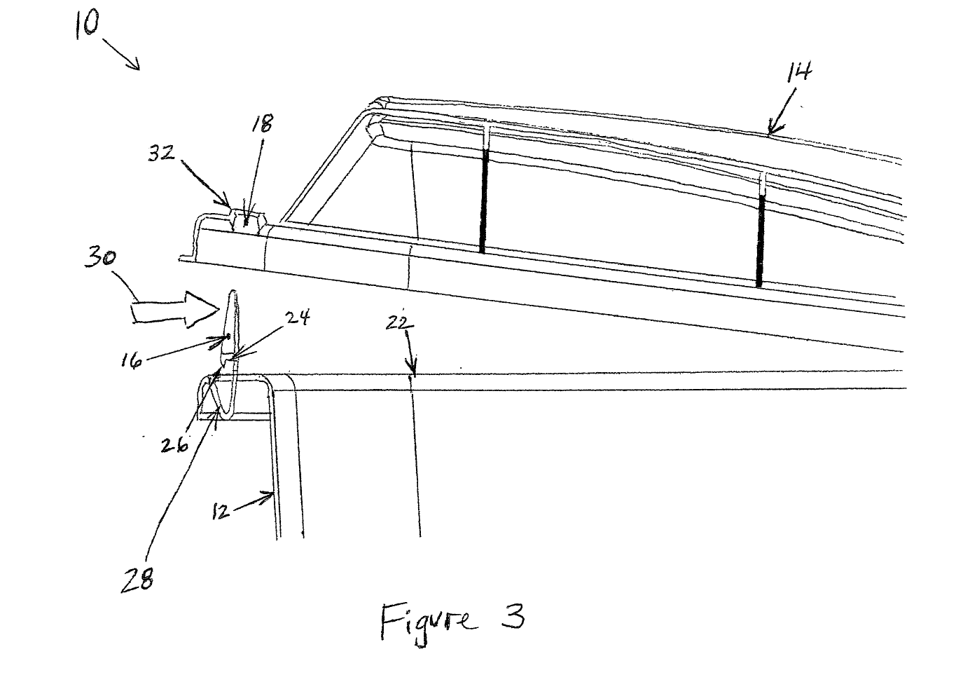

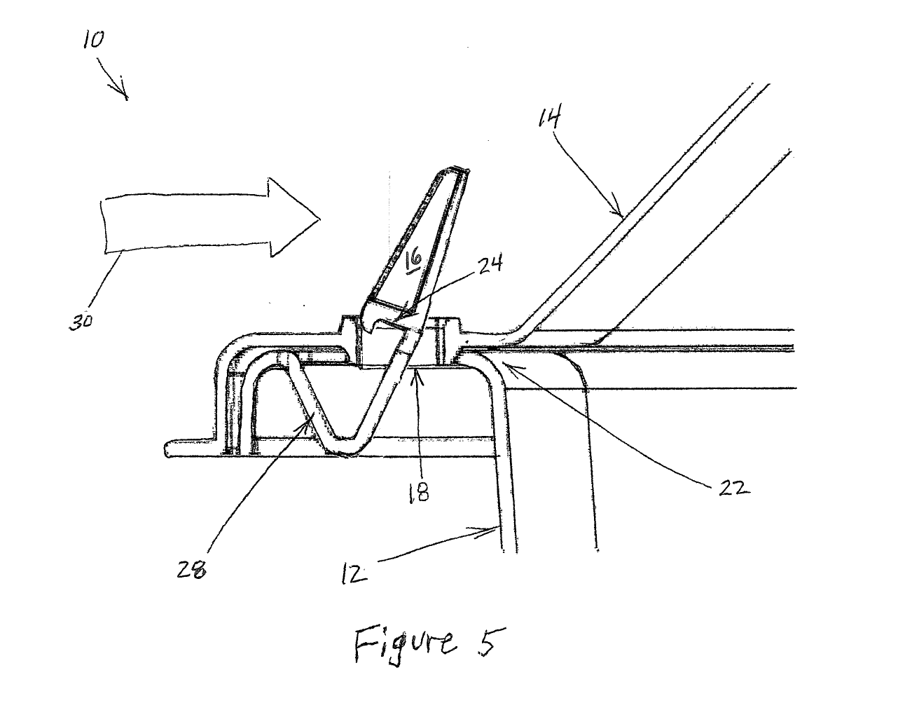

FIG. 3 is a cross-section of a container with lid latch 10 with container 12, lid 14 and latch 16. This view of this embodiment depicts the distal end of latch 16 with hold 24 and securing mechanism 26. Latch 16 protrudes from upper rim 22 of container 12. Latch 16 is coupled to flexible member 28 which is coupled to upper rim 22. When lid 14 approaches the closed configuration upon container 12, latch 16 is inserted through latch opening 18 and is pushed by a user's hand or thumb in the direction of force 30. When lid 14 reaches the closed configuration (shown in FIG. 5), hold 24 is pushed past latch opening 18, at which point retainer 32 maintains the location of hold 24 by providing resistance against the movement of securing mechanism 26.

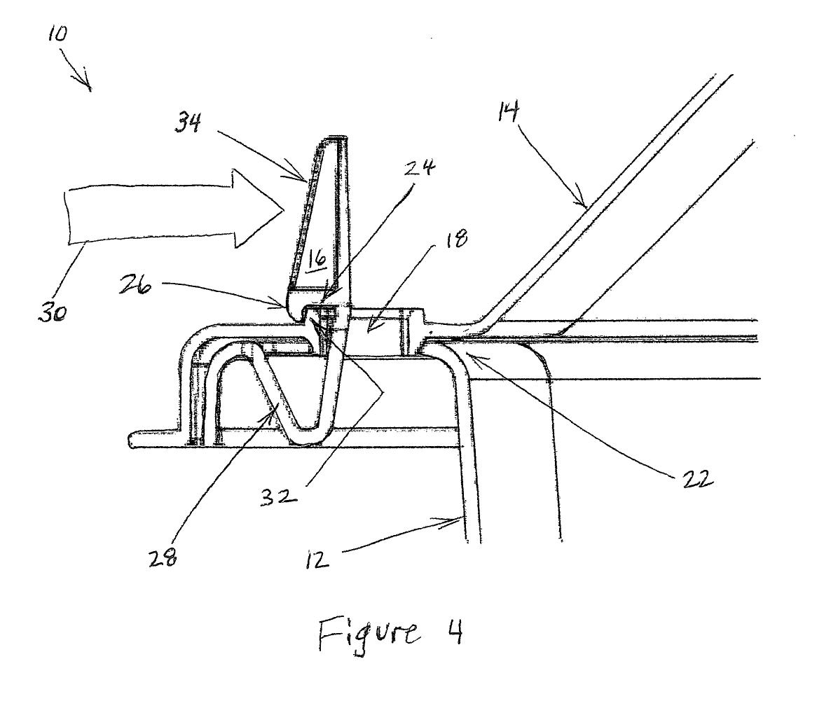

FIG. 4 is a detailed view of the FIG. 3 cross-section of container with lid latch 10 in the closed configuration. Upper rim 22 abuts lid 14 and distal latch 16 is secured with hold 24 overlapping the surface of lid 14 adjacent to the latch opening 18. This overlapped position is the neutral resting position of the latch 16. Latch 16 is secured in position because the securing mechanism 26 is held in place by retainer 32. A user may open lid 14 from container 12 by pushing the distal end of latch 16 in the direction of force 30 with enough pressure to overcome the resistance provided by retainer 32 against securing mechanism 26 so that hold 24 is aligned with latch opening 18. Angled surface 34 is shown opposing hold 24 on latch 16. When lid 14 approaches the closed configuration upon container 12, angled surface 36 comes into contact with the edge of latch opening 18. As lid 14 further approaches the closed configuration, latch 16 is pushed further in the direction of force 30, through the flexing of member 28 until hold 24 is aligned with latch opening 18. Latch 16 is then free to move all the way through latch opening 18 until hold 24 springs back, through the return of member 28 to its original orientation, placing hold 24 over the surface of lid 14 adjacent to latch opening 18.

FIG. 5 is a detailed view of the FIG. 3 cross-section of container with lid latch 10 with latch 16 pushed in the direction of force 30 so that hold 24 is aligned with latch opening 18, thereby allowing lid 14 to be moved away from container 12, which causes latch 16 to be withdrawn through latch opening 18.

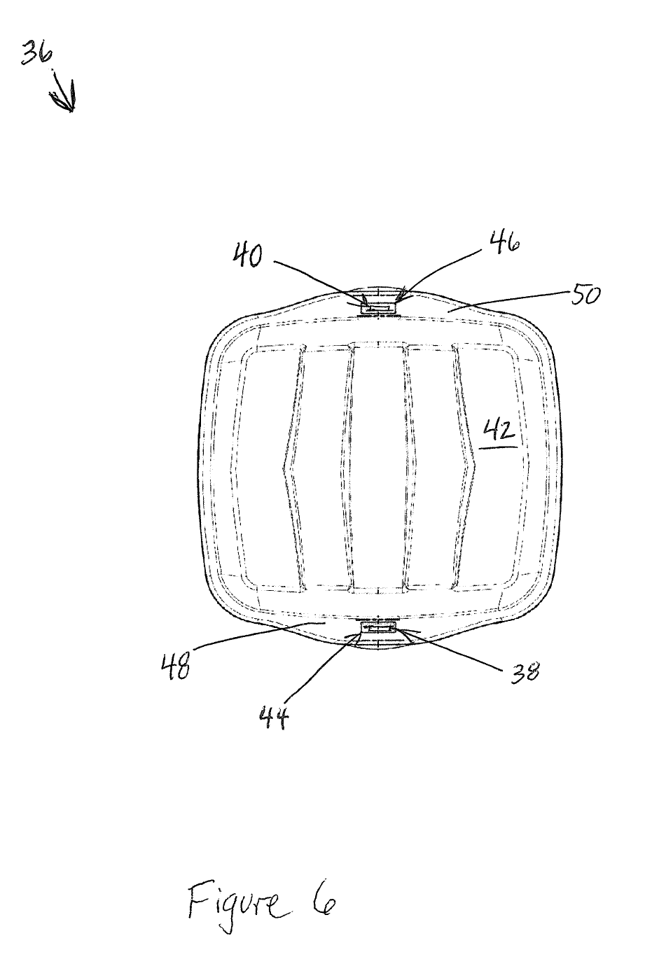

FIG. 6 is a top view of a container two lid latches 36 with two latches 38, 40 with lid 42 latched upon an open top container (not shown) in a closed configuration. Lid latch 38 is inserted through latch opening 44 and lid latch 40 is inserted through latch opening 46. Lid latches 38, 40 and latch openings 44, 46 are located within the broadened areas 48, 50. Lid 42 may be removed from the container (not shown) on which it is locked, by manipulating latches 38, 40 together in order to overcome retaining forces keeping them in place over the surface of lid 36 adjacent to latch openings 44, 46.

A number of implementations have been described. Nevertheless, it will be understood that additional modifications may be made without departing from the scope of the inventive concepts described herein, and, accordingly, other embodiments are within the scope of the following claims.

1. A container lid latch that secures a lid to an open top container, where the container has an upper rim, the lid latch comprising:
a latch on the upper rim, the latch comprising:
a distal end;
a hold; and
a securing mechanism;
a latch opening with a retainer, wherein the latch opening is in the lid;
wherein the distal end inserts through the latch opening when the lid is closing upon the container; and
wherein the lid is in a closed configuration upon the container when the hold is overlapping the lid adjacent to the latch opening with the latch resting in a neutral closed position and the hold positioned above the retainer, and the securing mechanism held adjacent and against the retainer.

2. The container lid latch of claim 1 wherein the lid is released from the closed configuration by applying a force to overcome a resistance provided by the retainer against the securing mechanism so that the latch may be positioned above, and withdrawn through, the latch opening.

3. The container lid latch of claim 2 further comprising a flexible member between the container and the latch.

4. The container lid latch of claim 3 wherein the flexible member is constructed and arranged to return the hold to the neutral closed position after the latch has been pushed or pulled and then released.

5. The container lid latch of claim 4 further comprising an angled surface on the distal end of the latch, opposing the hold.

6. The container lid latch of claim 5 wherein the hold is moved toward alignment with the latch opening as the lid approaches the closed configuration upon the open top container.

7. The container lid latch of claim 6 further comprising a hinge mechanism to which the lid and container are coupled, opposing the latch and the latch opening, and on which the lid may pivot from an open configuration to the closed configuration, and vice versa.

8-12. (canceled)

13. A container lid latch that secures a lid to an open top container, where the container has an upper rim, the lid latch comprising:
a latch on the upper rim, the latch comprising:
a distal end;
a hold; and
a securing mechanism;
a latch opening with a retainer, wherein the latch opening is in the lid;
a flexible member between the container and the latch;
an angled surface on the distal end of the latch, opposing the hold; and
a hinge mechanism to which the lid and container are coupled, opposing the latch and the latch opening, and on which the lid may pivot from an open configuration to a closed configuration, and vice versa;
wherein the distal end inserts through the latch opening when the lid is closing upon the container;
wherein the lid is in the closed configuration upon the container when the hold is overlapping the lid adjacent to the latch opening with the latch resting in a neutral closed position and the hold positioned above the retainer, and the securing mechanism is held adjacent and against the retainer;
wherein the lid is released from the closed configuration by applying a force to overcome a resistance provided by the retainer against the securing mechanism so that the latch may be positioned above, and withdrawn through, the latch opening;
wherein the flexible member is constructed and arranged to return the hold to the neutral closed position after the latch has been pushed or pulled and then released; and
wherein the hold is moved toward alignment with the latch opening as the lid approaches the closed configuration upon the open top container.
